(19) United States
(12) Patent Application Publication
(10) Pub. No.: US 2026/0244151 A1
(43) Pub. Date: Aug. 20, 2026

(54) IMAGE FORMING APPARATUS

(71) Applicant: Tadashi Sugiyama, Numazu Shizuoka (JP)

(72) Inventor: Tadashi Sugiyama, Numazu Shizuoka (JP)

(73) Assignee: ETRIA CO., LTD., Kanagawa (JP)

(21) Appl. No.: 19/276,271

(22) Filed: Jul. 22, 2025

(30) Foreign Application Priority Data
Feb. 14, 2025 (JP) 2025-022268

(51) Int. Cl. G03G 21/12; G03G 15/00; G03G 21/02

(52) U.S. Cl. CPC G03G 21/12; G03G 15/502; G03G 15/5075; G03G 21/02

(57) ABSTRACT

According to an embodiment, an image forming apparatus includes an image forming unit, a collection unit, a full level detector, a display unit, and a processor. The image forming unit forms an image using toner. The collection unit collects, in a storage unit, waste toner generated in image forming processing by the image forming unit. The full level detector detects that the storage unit is full. The display unit displays information indicating that the storage unit is nearly full. The processor adjusts a display timing at which the display unit displays the information indicating that the storage unit is nearly full so that the storage unit becomes full after a predetermined period.

### CROSS REFERENCE TO RELATED APPLICATIONS

This application is based upon and claims the benefit of priority from Japanese Patent Application No. 2025-22268, filed Feb. 14, 2025, the entire contents of which are incorporated herein by reference.

### FIELD

Embodiments described herein relate generally to an image forming apparatus.

### BACKGROUND

Conventionally, an image forming apparatus includes a collection unit that collects an image forming material unnecessary in the apparatus. For example, an electrophotographic image forming apparatus removes toner remaining on a photoreceptor or a transfer body by a cleaning mechanism. The image forming apparatus includes a waste toner collection unit that collects the toner removed by the cleaning mechanism as waste toner and stores the waste toner into a waste toner box.

When the waste toner box is full, the image forming apparatus stops operating. Therefore, the image forming apparatus detects that the amount of waste toner stored in the waste toner box has reached a predetermined amount close to a full level as a nearly full state. In a case where the nearly full state is detected, the conventional image forming apparatus performs display (nearly full state display) for guiding that the waste toner box is nearly full, for example, in order to prepare for replacement of the waste toner box by a user or a service person.

However, a period from when the amount of waste toner in the waste toner box reaches the predetermined amount corresponding to the nearly full state to when the waste toner box becomes full varies greatly depending on a usage condition, a usage environment, and the like. Therefore, in the conventional image forming apparatus, the nearly full state display may not be performed at an appropriate time. For example, in the image forming apparatus, when the waste toner box becomes full in a short period of time after the nearly full state display, a period for preparing a waste toner box or the like may be too short. If the waste toner box for replacement is not prepared when the waste toner box becomes full, there is a problem that the waste toner box cannot be immediately replaced in the image forming apparatus. In addition, in the image forming apparatus, when a period from when the nearly full state display is performed to when the waste toner box becomes full is too long, preparation of the waste toner box for replacement may be too early. If the waste toner box for replacement is prepared too early, there is a problem that the waste toner box for replacement needs to be stored for a long period of time in a place where the image forming apparatus is operated.

### DESCRIPTION OF THE DRAWINGS

FIG. 1 is a diagram illustrating an example of a configuration of a printing system including an image forming apparatus according to an embodiment.

FIG. 2 is a diagram illustrating an example of a configuration of the image forming apparatus according to the embodiment.

FIG. 3 is a block diagram illustrating an example of a configuration of a control system in the image forming apparatus according to the embodiment.

FIG. 4 is a diagram illustrating an example of arrangement of a waste toner collection unit in the image forming apparatus according to the embodiment.

FIG. 5 is a diagram illustrating an example of a configuration of the waste toner collection unit in the image forming apparatus according to the embodiment.

FIG. 6 is a diagram illustrating the example of the configuration of the waste toner collection unit in the image forming apparatus according to the embodiment.

FIG. 7 is a diagram illustrating an example of a configuration of a drive mechanism included in the waste toner collection unit in the image forming apparatus according to the embodiment.

FIG. 8 is a diagram illustrating an example of a configuration of a main part in the waste toner collection unit of the image forming apparatus according to the embodiment.

FIG. 9 is a diagram illustrating another example of the configuration of the waste toner collection unit in the image forming apparatus according to the embodiment.

FIG. 10 is a diagram illustrating the other example of the configuration of the waste toner collection unit in the image forming apparatus according to the embodiment.

FIG. 11 is a flowchart for explaining a first operation example in notification processing for notifying a state of the waste toner collection unit in the image forming apparatus according to the embodiment.

FIG. 12 is a flowchart for explaining the first operation example in the notification processing for notifying the state of the waste toner collection unit in the image forming apparatus according to the embodiment.

FIG. 13 is a flowchart for explaining a second operation example in the notification processing for notifying the state of the waste toner collection unit in the image forming apparatus according to the embodiment.

FIG. 14 is a flowchart for explaining the second operation example in the notification processing for notifying the state of the waste toner collection unit in the image forming apparatus according to the embodiment.

### DETAILED DESCRIPTION

According to an embodiment, an image forming apparatus includes an image forming unit, a collection unit, a full level detector, a display unit, and a processor. The image forming unit forms an image using toner. The collection unit collects, in a storage unit, waste toner generated in image forming processing by the image forming unit. The full level detector detects that the storage unit is full. The display unit displays information indicating that the storage unit is nearly full. The processor adjusts a display timing at which the display unit displays the information indicating that the storage unit is nearly full so that the storage unit becomes full after a predetermined period.

The image forming apparatus according to the embodiment will be described below with reference to the drawings.

Note that, in each drawing used in the following description of the embodiment, the scale of each part may be appropriately changed. In addition, in each drawing used in the following description of the embodiment, a configuration may be omitted for the sake of description.

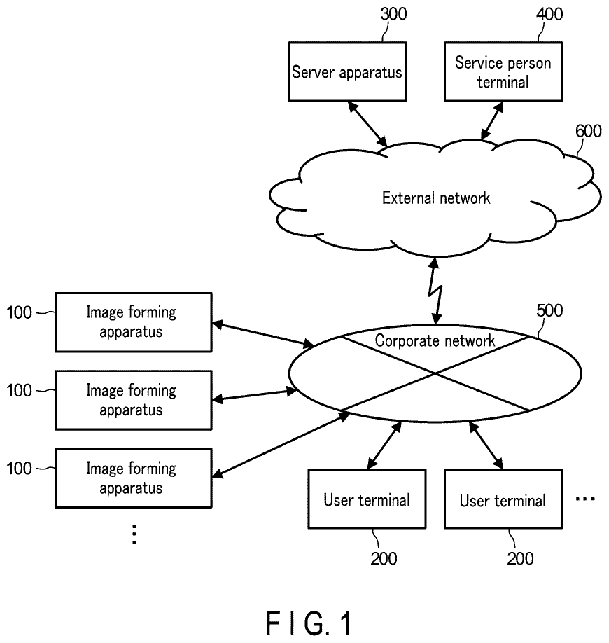

FIG. 1 is a schematic configuration diagram of a printing system (image forming system) including a plurality of image forming apparatuses 100 according to the embodiment. The printing system including the image forming apparatuses 100 further includes a plurality of user terminals 200, a server apparatus 300, and a service person terminal 400.

Each of the image forming apparatuses 100 is disposed in a workplace. Each of the image forming apparatuses 100 has a function of forming an image using an image forming material and collecting an unnecessary image forming material. In addition, each of the image forming apparatuses 100 is connected to a corporate network 500 (in a specific region), such as a local area network (LAN). The connection may be a wired connection or a wireless connection. Each of the image forming apparatuses 100 is communicably connected to, for example, the user terminals 200 arranged in the workplace via the corporate network 500.

In addition, the corporate network 500 is connected to the image forming apparatuses 100 and the user terminals 200 in the specific region. The corporate network 500 is further connected to an external network 600 such as the Internet via a communication control apparatus such as a server or a router that restricts unauthorized access.

The server apparatus 300 and the service person terminal 400 are connected to the external network 600. In the printing system having the configuration illustrated in FIG. 1, the image forming apparatuses 100 are communicably connected to the server apparatus 300 via the corporate network 500 and the external network 600.

The user terminals 200 are information processing apparatuses that instruct any of the image forming apparatuses 100 to perform printing. Each of the user terminals 200 is, for example, an information processing apparatus such as a personal computer (PC), a smartphone, a tablet terminal, or a digital camera. Note that the user terminals 200 may be communicably connected to the image forming apparatuses 100 via the external network 600 and the corporate network 500. That is, the user terminals 200 may be outside the workplace where the image forming apparatuses 100 are placed. The user terminals 200 may be directly connected to the image forming apparatuses 100 without the external network 600 and the corporate network 500. That is, the user terminals 200 may be locally connected to the image forming apparatuses 100. In a case where the user terminals 200 are locally connected to the image forming apparatuses 100, the connection may be a wired connection or a wireless connection.

The server apparatus 300 is an information processing apparatus for performing maintenance and management of the image forming apparatuses 100. For example, the server apparatus 300 is operated directly by a management company that undertakes maintenance and management of the image forming apparatuses 100 or by entrusting to a service provider. The server apparatus 300 acquires (collects) information such as maintenance information of each of the image forming apparatuses 100 periodically or as necessary. The maintenance information includes information indicating a usage condition of each of the image forming apparatuses 100. For example, the maintenance information includes information indicating the number of passed sheets (number of prints) subjected to printing processing, an elapsed time, a drive distance of a photosensitive drum, a drive time, a size and a type of the printed sheets, and the like, and information indicating a state of each unit. The server apparatus 300 may acquire notification data such as an alert transmitted from each of the image forming apparatuses 100.

The server apparatus 300 determines the necessity of inspection or repair (maintenance) of each of the image forming apparatuses 100 based on the acquired data. In a case where an image forming apparatus 100 that requires maintenance is present, the server apparatus 300 transmits, to the service person terminal 400, information identifying the image forming apparatus 100 that requires maintenance. When the image forming apparatus 100 that requires maintenance is notified by the service person terminal 400, a service person can proceed to the maintenance of the image forming apparatus 100 in accordance with the content of the notification.

The server apparatus 300 includes a computer having a processor, a memory, and a communication interface (I/F). The processor is, for example, a CPU. The processor executes various types of processing by executing a program stored in the memory. The communication interface is an interface for communicating with each apparatus via the network 600. The memory includes a storage apparatus such as a ROM, a RAM, and a non-volatile memory.

For example, the server apparatus 300 stores, in the memory, information such as the maintenance information acquired from each of the image forming apparatuses 100. The processor of the server apparatus 300 determines the necessity of maintenance on each of the image forming apparatuses based on the information acquired from each of the image forming apparatuses 100. Further, in response to a request from a specific image forming apparatus 100, the processor of the server apparatus 300 may provide, to the specific image forming apparatus 100, information regarding a usage condition and a usage environment of another image forming apparatus 100. For example, in response to a request from the specific image forming apparatus 100, the processor of the server apparatus 300 may provide information regarding the usage condition and the usage environment of the other image forming apparatus 100 connected to the same corporate network 500 to which the specific image forming apparatus 100 is connected.

The service person terminal 400 is an information processing apparatus such as a smartphone or a tablet terminal carried by the service person who performs maintenance of the image forming apparatuses 100. Although FIG. 1 illustrates only one service person terminal 400, the printing system may include a plurality of service person terminals 400. The service person terminal 400 may have a position detection function and transmit a position detected by the position detection function to the server apparatus 300 as position information of the service person. The server apparatus 300 can also assign an appropriate service person to an image forming apparatus 100 that requires maintenance, based on information such as position information of each service person and the availability of each service person.

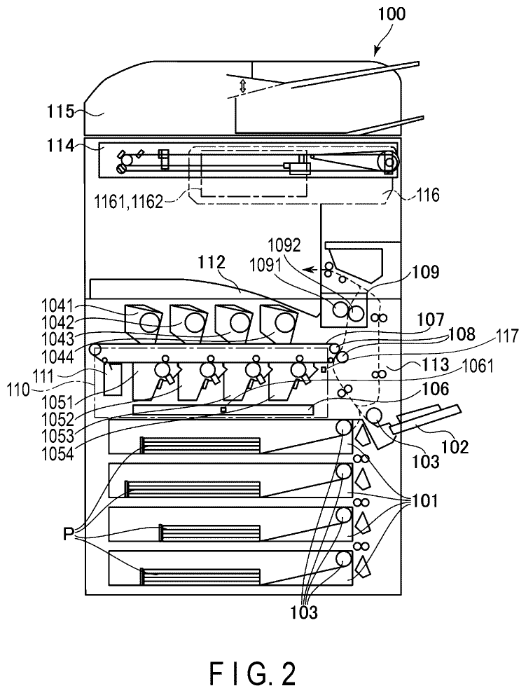

FIG. 2 is a diagram illustrating an example of a configuration of the image forming apparatus 100 according to the embodiment.

In the example of the configuration illustrated in FIG. 2, the image forming apparatus 100 is a digital multifunction peripheral (MFP) having functions of a copier, a printer, a scanner, a facsimile, and the like. Hereinafter, it is assumed that the digital multifunction peripheral as the image forming apparatus 100 according to the embodiment includes an image forming unit that forms an image using toner as an image forming material by an electrophotographic method.

In the example of the configuration illustrated in FIG. 2, the image forming apparatus 100 includes a sheet feeding tray 101, a manual feeding tray 102, a conveyance unit 103, a toner cartridge 104, an image forming unit 105, a transfer belt 107, a transfer roller 108, a fixing unit 109, a waste toner collection unit 110, a sheet ejection tray 112, a duplex unit 113, a scanner 114, a document feeder 115, a control panel 116, and the like.

The image forming unit 105 prints an image by an electrophotographic method. The image forming unit 105 forms an image to be printed on an image forming medium P or the like using toner. The image forming medium P is, for example, sheet-like paper (paper sheet). The scanner 114 reads an image from a document or the like on which the image is formed. For example, the image forming apparatus 100 implements copying of the image of the document by printing the image read from the document by the scanner 114 on the image forming medium P by the image forming unit 105.

The sheet feeding tray 101 stores the image forming medium P used for printing. The manual feeding tray 102 is a table for manually feeding the image forming medium P. The conveyance unit 103 conveys the image forming medium P present in the sheet feeding tray 101 or the manual feeding tray 102. The conveyance unit 103 includes various rollers. Each of the rollers constituting the conveyance unit 103 is rotated by a motor whose driving is controlled by a control signal. For example, a sheet feeding roller of the conveyance unit 103 rotates by the action of the motor to take out the image forming medium P stored in the sheet feeding tray 101 from the sheet feeding tray 101.

The image forming apparatus 100 includes the toner cartridge 104 that stores toner to be supplied to the image forming unit 105. In the example of the configuration illustrated in FIG. 2, the image forming apparatus 100 includes four toner cartridges 104 as four toner cartridges 1041, 1042, 1043, and 1044. For example, each of the toner cartridge 1041, the toner cartridge 1042, the toner cartridge 1043, and the toner cartridge 1044 stores toner corresponding to a respective one of colors, cyan, magenta, yellow, and key (black) (CMYK).

However, the colors of the toner stored in the toner cartridges 104 are not limited to the colors CMYK, and may be other colors. The toner stored in the toner cartridges 104 may be a special toner. For example, the toner cartridges 104 may store a decolorable toner that is decolored at a temperature higher than a predetermined temperature and becomes invisible.

The image forming apparatus 100 includes a plurality of image forming units as the image forming unit 105. In the example illustrated in FIG. 2, the image forming apparatus 100 includes four image forming units 105 that are an image forming unit 1051, an image forming unit 1052, an image forming unit 1053, and an image forming unit 1054. Each of the image forming unit 1051, the image forming unit 1052, the image forming unit 1053, and the image forming unit 1054 receives toner corresponding to a respective one of the colors CMYK and forms an image with the toner.

Each of the image forming units 1051, 1052, 1053, and 1054 includes a developer, a charger, a photosensitive drum, a cleaner, and the like. The surface of the photosensitive drum is uniformly charged by the charger. The surface of the photosensitive drum is exposed to light from an exposure apparatus after being charged by the charger, whereby an electrostatic latent image is formed on the surface of the photosensitive drum. The developer develops the electrostatic latent image on the surface of the photosensitive drum using the toner supplied from the toner cartridge 104. As a result, a toner image is formed on the surface of the photosensitive drum. The image formed on the surface of the photosensitive drum is transferred (primarily transferred) onto the transfer belt 107.

In each of the image forming units 1051, 1052, 1053, and 1054, the surface of the photosensitive drum after the toner image is transferred to the transfer belt 107 is cleaned by the cleaner. The cleaner in each of the image forming units 1051, 1052, 1053, and 1054 removes toner remaining on the surface of the photosensitive drum.

The waste toner collection unit 110 collects the waste toner generated in the image forming apparatus 100. The waste toner collection unit 110 collects the excess toner generated in each of the image forming units 1051, 1052, 1053, and 1054 as waste toner. For example, the waste toner collection unit 110 collects, as the waste toner, the toner removed from the photosensitive drum by the cleaner in each of the image forming units 1051, 1052, 1053, and 1054.

The exposure apparatus 106 is also referred to as a laser scanning unit (LSU) or the like. The exposure apparatus 106 forms an electrostatic latent image on the surface of the photosensitive drum of each of the image forming units 105 with laser light controlled according to image data. The exposure apparatus 106 includes, for example, a housing, laser units, a polygon mirror, a polygon motor, a mirror, a lens, and the like. Further, the exposure apparatus 106 includes a temperature sensor 1061. The housing supports the laser units, the polygon mirror, the polygon motor, the mirror, the lens, the temperature sensor 1061, and the like. The housing is made of resin, for example.

As an example, the exposure apparatus 106 includes the laser units corresponding to the respective colors of CMYK. Each of the laser units corresponding to the respective colors emits laser light. Each of the laser units controls emission of laser light in accordance with a control signal corresponding to image data. Each of the laser units modulates the laser light in accordance with the control signal corresponding to the image data.

Further, the exposure apparatus 106 includes the polygon mirror, the polygon motor, the mirror, and the like. The polygon mirror reflects laser light emitted from each of the laser units. The polygon mirror rotates by the polygon motor to subject the laser beam from each of the laser units to deflection scanning. The polygon motor is a motor that rotates the polygon mirror. The mirror and the lens are optical elements for manipulating laser light. The mirror is provided so that the position or the angle of the mirror with respect to the housing can be adjusted.

Further, the exposure apparatus 106 is provided with the temperature sensor 1061. The temperature sensor 1061 detects a temperature inside the exposure apparatus 106. As an example, the temperature sensor 1061 is installed in the housing of the exposure apparatus 106 described above. The temperature sensor 1061 outputs the measured temperature. The temperature sensor 1061 is, for example, a thermistor.

The transfer belt 107 is, for example, an endless belt supported by a roller. The transfer belt 107 is configured such that one round has a predetermined length. The transfer belt 107 is rotated by the action of the roller. When the transfer belt 107 rotates, an image is transferred (primarily transferred) by a transfer roller (primary transfer roller) of each of the image forming units 1051 to 1054. The transfer belt 107 conveys the images (toner images) transferred from the image forming units 1051 to 1054 to the position (secondary transfer position) of the transfer roller 108.

The transfer roller 108 includes two rollers facing each other. The transfer roller 108 transfers (secondarily transfers) the toner images formed on the transfer belt 107 onto the image forming medium P passing between the two rollers of the transfer roller 108. The position where the two rollers of the transfer roller 108 face each other is the secondary transfer position where the images are transferred from the transfer belt 107 to the image forming medium P.

The toner sensor 117 detects toner adhering to the transfer belt 107. For example, the toner sensor 117 detects toner in the toner images transferred to the transfer belt 107 as a pattern for alignment control and image quality maintenance control. The toner sensor 117 detects the toner images on the transfer belt 107 between a transfer position (primary transfer position) of the image forming unit 1054 and the position (secondary transfer position) where the toner images on the transfer belt 107 face the transfer roller 108. For example, the toner sensor 117 is disposed to face the transfer belt 107 between the primary transfer position of the image forming unit 1054 and the secondary transfer position where the transfer is performed by the transfer roller 108.

The belt cleaner 111 cleans the surface of the transfer belt 107 by removing the toner remaining on the transfer belt 107. The belt cleaner 111 cleans the transfer belt 107 in a region from the secondary transfer position to the transfer position (primary transfer position) of the image forming unit 1051.

For example, the belt cleaner 111 removes the toner remaining on the transfer belt 107 without moving to the image forming medium P at the secondary transfer position where the transfer roller 108 is disposed. The belt cleaner 111 also removes toner or the like transferred to the transfer belt 107 due to alignment or image quality maintenance control in which toner is not transferred onto the image forming medium P at the secondary transfer position. The toner removed from the transfer belt 107 by the belt cleaner 111 is collected as waste toner by the waste toner collection unit 110.

The fixing unit 109 heats and pressurizes the image forming medium P to which the toner images have been transferred. As a result, the toner images transferred onto the image forming medium P are fixed as an image. The fixing unit 109 includes a heating unit 1091 and a pressure roller 1092 that face each other.

The heating unit 1091 is, for example, a roller including a heat source for heating the image forming medium P. The heat source is, for example, a heater. The roller heated by the heat source heats the image forming medium P. The pressure roller 1092 pressurizes the image forming medium P passing between the pressure roller 1092 and the heating unit 1091.

Further, the heating unit 1091 may include an endless belt suspended around a plurality of rollers. For example, the heating unit 1091 includes the plate-like heat source, the endless belt, a belt conveyance roller, a tension roller, and a press roller. The endless belt is, for example, a film-shaped member. The belt conveyance roller drives the endless belt. The tension roller applies tension to the endless belt. An elastic layer is formed on a surface of the press roller. The plate-shaped heat source forms a fixing nip having a predetermined width between the plate-shaped heat source and the press roller when a heat generating portion side comes into contact with the inner side of the endless belt and is pressed toward the press roller. Since the plate-shaped heat source is configured to heat while forming the nip area, responsiveness at the time of energization is higher than that in the case of a heating method using a halogen lamp.

In the endless belt, for example, a silicon rubber layer having a thickness of 200 μm is formed outside a steel use stainless (SUS) substrate having a thickness of 50 μm or polyimide which is a heat-resistant resin having a thickness of 70 μm, and the outermost periphery is covered with a surface protective layer such as perfluoroalkoxy alkane (PFA). In the press roller, for example, a silicon sponge layer having a thickness of 5 mm is formed on the surface of an iron bar having a diameter of 10 mm, and the outermost periphery is covered with a surface protective layer such as PFA.

In the plate-shaped heat source, for example, a glaze layer and a heat generation resistance layer are stacked on a ceramic substrate. A heat sink made of aluminum is bonded to the plate-like heat source in order to release excessive heat to the opposite side and to prevent warpage of the substrate. The heat generation resistance layer is formed of a known material such as TaSiO2, for example, and is divided into a predetermined number of portions having a predetermined length in a main scanning direction.

The sheet ejection tray 112 is a table onto which the image forming medium P on which printing has been completed is ejected.

The duplex unit 113 enables a back surface of the image forming medium P to be printed. For example, the duplex unit 113 reverses the front and back sides of the image forming medium P by switching back the image forming medium P using a roller or the like.

The scanner 114 reads the image from the document. The scanner 114 is an image reading apparatus for reading the image from the document. The scanner 114 is, for example, an optical reduction type image reading apparatus including an imaging element such as a charge-coupled device (CCD) image sensor. Further, the scanner 114 may be a contact image sensor (CIS) type image reading apparatus including an imaging element such as a complementary metal-oxide-semiconductor (CMOS) image sensor.

The document feeder 115 is also referred to as, for example, an auto document feeder (ADF). The document feeder 115 conveys documents placed on a document tray one after another. The image of the conveyed document is read by the scanner 114. Further, the document feeder 115 may include a scanner for reading an image from the back surface of the document.

The control panel 116 includes a display unit 1161 and an operation unit 1162. The display unit 1161 includes a display device that displays information. The operation unit 1162 includes input devices such as a touch panel and an operation button for the user to input an operation instruction. For example, the control panel 116 includes a display apparatus with a touch panel, a display such as an LED, an operation button, and the like. The display apparatus with the touch panel in the control panel 116 is obtained by stacking the touch panel including a touch sensor on a display screen of a display such as a liquid crystal display or an organic EL display.

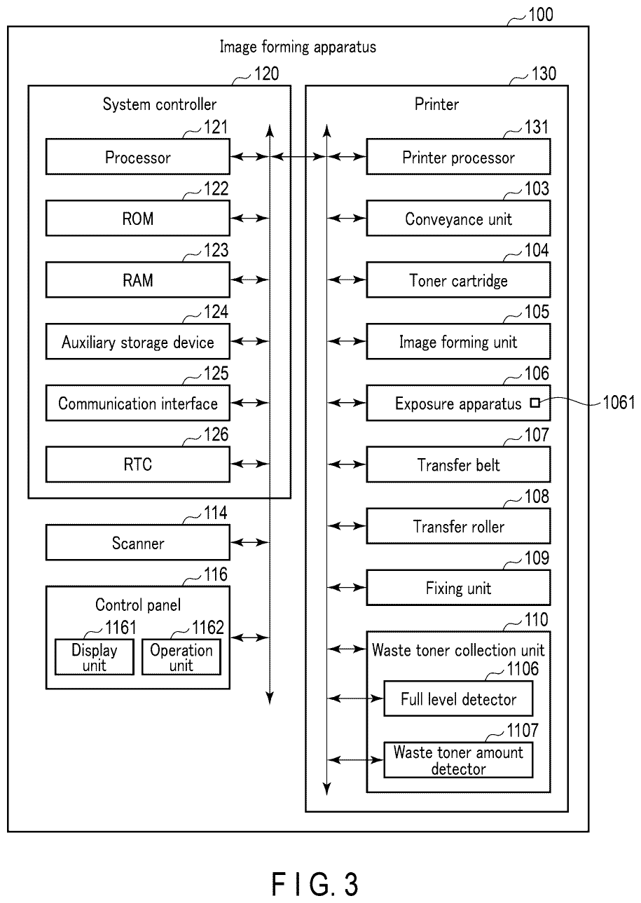

Next, a configuration of a control system in the image forming apparatus 100 according to the embodiment will be described. FIG. 3 is a block diagram illustrating an example of the configuration of the control system in the image forming apparatus 100 according to the embodiment.

In the example of the configuration illustrated in FIG. 3, the image forming apparatus 100 as the digital multifunction peripheral includes a system controller 120 that controls the entire apparatus. The system controller 120 comprehensively controls the scanner 114, the control panel 116, and the printer 130.

The system controller 120 includes a processor 121, a read-only memory (ROM) 122, a random-access memory (RAM) 123, an auxiliary storage device 124, a communication interface 125, a real-time clock (RTC) 126, and the like. The processor 121 of the system controller 120 is connected to the scanner 114, the control panel 116, and the printer 130.

The processor 121 corresponds to a central part of a computer that performs processing such as calculation and control necessary for the operation of the image forming apparatus 100. The processor 121 controls each unit to implement various functions of the image forming apparatus 100 based on a program such as system software, application software, or firmware stored in the ROM 122, the auxiliary storage device 124, or the like.

The processor 121 is, for example, a central processing unit (CPU), a micro processing unit (MPU), a system on a chip (SoC), a digital signal processor (DSP), a graphics processing unit (GPU), an application specific integrated circuit (ASIC), a programmable logic device (PLD), a field-programmable gate array (FPGA), or the like. Alternatively, the processor 121 is a combination of two or more of these.

The ROM 122 corresponds to a main storage apparatus of the computer mainly including the processor 121. The ROM 122 is a non-volatile memory exclusively used for reading data. The ROM 122 stores the above-described program. Further, the ROM 122 stores data, various setting values, or the like to be used by the processor 121 to perform various types of processing.

The RAM 123 corresponds to the main storage apparatus of the computer mainly including the processor 121. The RAM 123 is a memory used to read and write data. The RAM 123 is used as a so-called work area or the like in which data that is temporarily used when the processor 121 performs the various types of processing is stored.

The auxiliary storage device (memory) 124 corresponds to an auxiliary storage apparatus (data memory) of the computer mainly including the processor 121. The auxiliary storage device 124 is, for example, an electrically erasable programmable read-only memory (EEPROM), a hard disk drive (HDD), a solid state drive (SSD), or the like.

The auxiliary storage device 124 may store the program. In addition, the auxiliary storage device 124 stores data to be used when the processor 121 performs the various types of processing, data generated by processing in the processor 121, various setting values, or the like. For example, the auxiliary storage device 124 is a memory that stores a default setting value to be used in an operation to be described later, a correction value and a threshold set according to the usage condition, various variables, and the like.

Note that the image forming apparatus 100 may include an interface into which a storage medium such as a memory card or a Universal Serial Bus (USB) memory can be inserted, instead of the auxiliary storage device 124 or in addition to the auxiliary storage device 124.

The program stored in the ROM 122 or the auxiliary storage device 124 includes a program for executing processing to be described later. As an example, the image forming apparatus 100 is transferred to an administrator or the like of the image forming apparatus 100 in a state where the program is stored in the ROM 122 or the auxiliary storage device 124. The image forming apparatus 100 may be transferred to the administrator or the like in a state where the program is not stored in the ROM 122 or the auxiliary storage device 124.

In addition, the program for executing the processing to be described later may be written to the ROM 122 or the auxiliary storage device 124 by an operation by the administrator, the service person, or the like. The transfer of the program can be effected, for example, by recording the program in a removable storage medium such as a magnetic disk, a magneto-optical disk, an optical disk, or a semiconductor memory, or by downloading the program via a network or the like.

The communication interface 125 is an interface for the image forming apparatus 100 to communicate via the network or the like. The communication interface 125 is connected to a terminal apparatus that is operated by the user.

The RTC 126 counts an elapsed time, elapsed days, and the like. The RTC 126 includes a clock or a circuit with a built-in clock function.

The scanner 114 reads the image of the document. The scanner 114 operates under control by the processor 121 of the system controller 120. For example, the scanner 114 reads the image of the document set on a platen in response to a scan instruction from the processor 121, and supplies the read image of the document to the system controller 120. The scanner 114 is also connected to the document feeder 115. The scanner 114 sets a reading position of the document at a predetermined position and instructs the document feeder 115 to convey the document. The scanner 114 reads the image of the document conveyed by the document feeder 115 and supplies the read image of the document to the system controller 120.

The display unit 1161 and the operation unit 1162 of the control panel 116 are connected to the system controller 120. Display contents of the display unit 1161 are controlled by the processor 121 of the system controller 120. For example, the processor 121 causes the display unit 1161 to display various operation guides, warnings, and the like. In the present embodiment, the processor 121 causes the display unit 1161 to display information indicating that the amount of waste toner collected by the waste toner collection unit 110 described later has reached a full level and that the amount of waste toner collected by the waste toner collection unit 110 has reached an amount (nearly full level) close to the full level.

In addition, the operation unit 1162 supplies information indicating the content of an input instruction to the processor 121 of the system controller 120. For example, the processor 121 causes the display apparatus with the touch panel to display various operation icons, acquires information indicating a touch position detected by the touch panel as the operation unit 1162, and recognizes an input operation instruction.

Next, an example of a configuration of a control system of the printer 130 that prints an image on the image forming medium P in the image forming apparatus 100 will be described.

The printer 130 is connected to the system controller 120. The printer 130 includes a printer processor 131 in addition to the conveyance unit 103, the toner cartridge 104, the image forming unit 105, the exposure apparatus 106, the transfer belt 107, the transfer roller 108, the fixing unit 109, the waste toner collection unit 110, and the like described above. Each of the units of the printer 130 is connected to the processor 121 of the system controller 120.

The printer processor 131 performs processing such as calculation and control necessary for a printing operation of the image forming apparatus 100 in order to implement a print function. The printer processor 131 is connected to the processor 121 of the system controller. The printer processor 131 performs processing such as calculation and control necessary for a printing operation based on an instruction or the like from the processor 121 and various programs. The printer processor 131 includes, for example, a CPU, an MPU, an SoC, a DSP, a GPU, an ASIC, a PLD, an FPGA, or the like. Further, the various programs that are executed by the printer processor 131 may be stored in a storage unit such as the ROM 122 or the auxiliary storage device 124, or may be stored in a storage unit disposed in the printer 130.

The printer processor 131 executes printing processing of printing an image on a paper sheet by controlling each unit of the printer 130 in accordance with an instruction from the processor 121. Further, the printer processor 131 collects information indicating an operation result and the like from each unit in the printer 130, and supplies the collected information to the processor 121. For example, the printer processor 131 supplies information acquired from each sensor in the printer 130 to the processor 121.

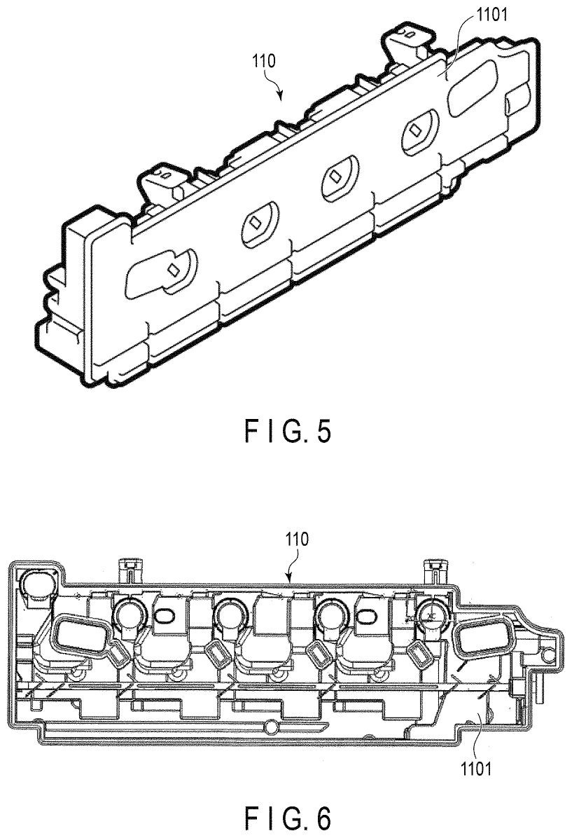

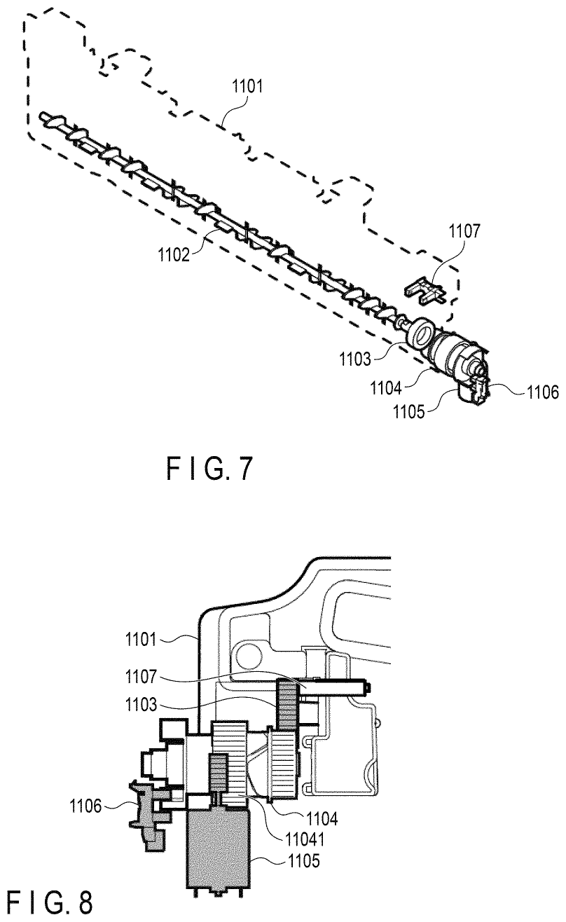

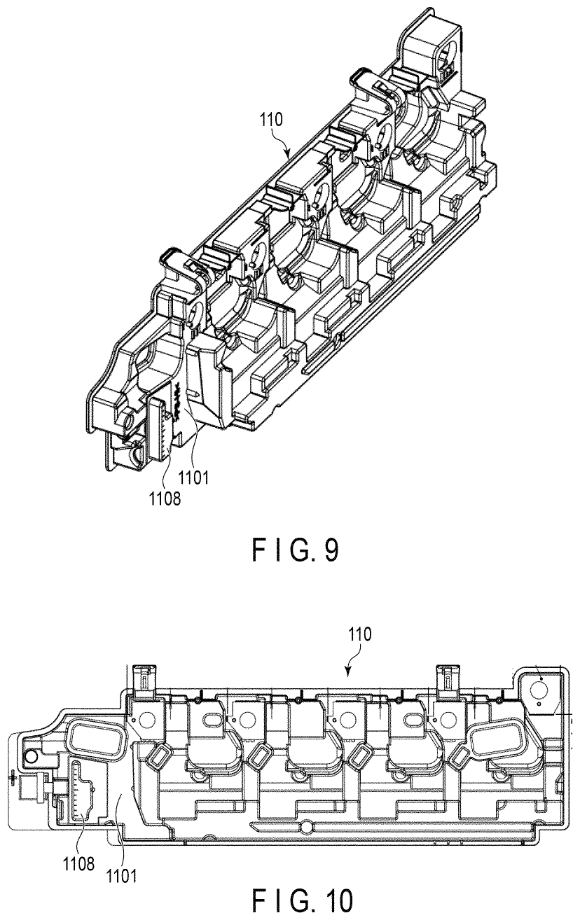

As described above, the waste toner collection unit 110 collects waste toner generated in the printer 130 in a main body of the image forming apparatus 100. The waste toner collection unit 110 includes a waste toner box 1101 (see FIGS. 5 to 9) as a storage unit that stores waste toner. The waste toner collection unit 110 can store a predetermined allowable amount of waste toner in the waste toner box 1101. In the example of the configuration illustrated in FIG. 3, the waste toner collection unit 110 includes a full level detector 1106 (see FIGS. 7 and 8) and a waste toner amount detector 1107 (see FIGS. 9 and 20). The full level detector 1106 and the waste toner amount detector 1107 are connected to the processor 121 and the printer processor 131.

The full level detector 1106 detects that the amount of waste toner collected by the waste toner collection unit 110 and stored in the waste toner box 1101 has reached the allowable amount (full level).

The waste toner amount detector (toner amount sensor) 1107 detects that the amount of waste toner stored in the waste toner box 1101 by the waste toner collection unit 110 has reached a predetermined amount. For example, the waste toner amount detector 1107 may function as a nearly full level detector that detects that the amount of waste toner stored in the waste toner box 1101 has reached the predetermined amount corresponding to a nearly full state before the amount of waste toner stored in the waste toner box 1101 reaches the full level.

The waste toner amount detector 1107 may function as a full level detector that detects that the amount of waste toner stored in the waste toner box 1101 reaches the full level. However, the waste toner collection unit 110 may not be provided with the waste toner amount detector 1107, and the processor 121 or the printer processor 131 may calculate (predict) the amount of waste toner stored in the waste toner box 1101.

Next, an example of a configuration of the waste toner collection unit 110 in the image forming apparatus 100 according to the embodiment will be described.

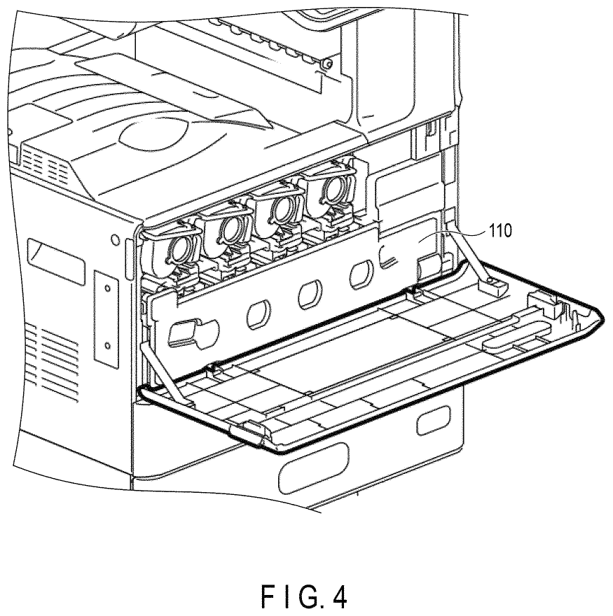

FIG. 4 is a diagram illustrating an example of arrangement of the waste toner collection unit 110 in the image forming apparatus 100 according to the embodiment.

The waste toner collection unit 110 is disposed at a position where waste toner generated in the image forming apparatus 100 can be collected. The waste toner collection unit 110 is disposed in proximity to waste toner generation sources such as the image forming unit 105 and the belt cleaner 111 in the image forming apparatus 100.

For example, as illustrated in FIG. 4, the waste toner collection unit 110 is disposed inside a front cover disposed in a housing of the image forming apparatus 100. The waste toner collection unit 110 is configured such that the waste toner box 1101 can be replaced in a state where the front cover of the image forming apparatus 100 is opened. The image forming apparatus 100 has a structure in which the front cover is not closed in a state where the waste toner box 1101 is not attached to the waste toner collection unit 110.

FIG. 5 is a perspective view illustrating an example of an external configuration of the waste toner collection unit 110 in the image forming apparatus 100 according to the embodiment. FIG. 6 is a cross-sectional view illustrating an example of a configuration of the inside of the waste toner collection unit 110 in the image forming apparatus 100 according to the embodiment.

As illustrated in FIGS. 5 and 6, the waste toner collection unit 110 includes the waste toner box 1101 as a storage unit that stores waste toner. The waste toner box 1101 is formed as a housing for constituting the waste toner collection unit 110. The waste toner box 1101 stores waste toner generated in each image forming unit 105 and waste toner removed from the transfer belt 107 by the belt cleaner 111.

FIG. 7 is a diagram illustrating an example of a configuration of a drive mechanism in the waste toner collection unit 110 in the image forming apparatus 100 according to the embodiment. FIG. 8 is a diagram illustrating an example of a configuration of a main part in the waste toner collection unit 110 of the image forming apparatus 100 according to the embodiment.

As illustrated in FIGS. 7 and 8, the waste toner collection unit 110 includes the waste toner box 1101, a paddle 1102, a paddle drive gear 1103, a drive transmission gear 1104, a paddle motor 1105, and a rotation sensor 1106.

The paddle 1102 is provided with a screw (spiral feather-like body) continuous or divided into a plurality of segments in the axial direction of a rotation shaft. The paddle 1102 conveys the waste toner in the waste toner box 1101 while stirring the waste toner in accordance with a direction in which the screw is rotated by the rotation of the rotation shaft. The paddle 1102 stirs the waste toner stored in the waste toner box 1101 by the rotation of the rotation shaft to make the height of the waste toner in the waste toner box 1101 uniform. The paddle 1102 has a function of not only stirring the waste toner but also conveying the waste toner in the waste toner box 1101. When the waste toner is accumulated in the waste toner box 1101, the paddle 1102 presses and solidifies the waste toner with this function.

In the example of the configuration illustrated in FIGS. 7 and 8, the paddle 1102 is provided with the paddle drive gear 1103 on the rotation shaft. The paddle drive gear 1103 is arranged to mesh with the drive transmission gear 1104. The drive transmission gear 1104 includes a movable gear portion 11041. The movable gear portion 11041 is connected to the paddle motor 1105. As a result, the rotation of the paddle motor 1105 is transmitted to the rotation shaft of the paddle 1102 via the drive transmission gear 1104 and the paddle drive gear 1103. That is, the paddle 1102 is rotated by a drive force transmitted from the paddle motor 1105 to the paddle drive gear 1103 via the drive transmission gear 1104.

Further, a movable portion 11041 of the drive transmission gear 1104 is provided to be movable (slidable) in a predetermined axial direction. The movable portion 11041 slides as the amount of waste toner in the waste toner box 1101 increases and drive torque increases. When waste toner in the predetermined allowable amount is accumulated in the waste toner box 1101, the movable portion 11041 slides in the predetermined axial direction by a load (increase in the density of waste toner) due to the accumulated waste toner and is separated from the paddle motor 1105.

When the movable portion 11041 of the drive transmission gear 1104 moves to a predetermined position, the movable portion 11041 and a rotation shaft of the paddle motor 1105 are disengaged from each other and separated from each other. When the movable portion 11041 and the paddle motor 1105 are separated from each other, the rotation of the paddle motor 1105 is not transmitted to the rotation shaft of the paddle 1102, so that the paddle 1102 does not rotate. The waste toner collection unit 110 is configured such that the movable portion 11041 and the paddle motor 1105 are separated from each other when the amount of waste toner in the waste toner box 1101 reaches the full level (predetermined amount corresponding to a full state, the allowable amount of the waste toner box 1101). In this case, it is possible to detect that the waste toner box 1101 is full of the waste toner by detecting that the movable portion 11041 and the paddle motor 1105 are separated from each other.

In the example of the configuration illustrated in FIGS. 7 and 8, the full level detector 1106 is a rotation sensor. The rotation sensor 1106 as the full level detector detects the rotation of the paddle 1102. When the waste toner box 1101 becomes full of the waste toner, the paddle 1102 does not rotate because the movable portion 11041 and the paddle motor 1105 are separated from each other. When the movable portion 11041 and the paddle motor 1105 are separated from each other and the paddle 1102 does not rotate, the rotation sensor 1106 detects non-rotation (rotation abnormality detection/rotation undetectable) of the paddle 1102.

Therefore, when the rotation sensor 1106 detects the non-rotation of the paddle 1102, the fact that the waste toner box 1101 is full is detected. That is, in the example of the configuration illustrated in FIGS. 7 and 8, the rotation sensor 1106 serves as the full level detector that detects that the waste toner box 1101 is full of the waste toner (and that the amount of the waste toner has reached the allowable amount). Note that, since the rotation sensor 1106 detects whether the rotation of the paddle motor 1105 is transmitted to the rotation shaft of the paddle 1102, it is also possible to detect that the waste toner box 1101 is incorrectly installed or the like.

FIG. 9 is an external view illustrating another example of the configuration of the waste toner collection unit 110 in the image forming apparatus 100 according to the embodiment. FIG. 10 is a cross-sectional view illustrating the other example of the configuration of the waste toner collection unit 110 in the image forming apparatus 100 according to the embodiment.

FIGS. 9 and 10 illustrate an example of a configuration in which the sensor as the waste toner amount detector 1107 is disposed in the waste toner collection unit 110. The waste toner amount detector 1107 includes the sensor that optically detects that the amount of waste toner in the waste toner box has reached a predetermined amount (for example, the predetermined amount to be used to determine the nearly full state or the allowable amount to be used to determine the full state).

For example, the waste toner amount detector 1107 may be a sensor (nearly full level sensor) that detects that the amount of waste toner in the waste toner box 1101 has reached the predetermined amount to be used to determine the nearly full state. In addition, the waste toner amount detector 1107 may include a sensor (full state sensor) that detects that the amount of waste toner in the waste toner box 1101 has reached the predetermined amount (allowable amount) to be used to determine the full state. In this case, the waste toner amount detector 1107 as the full level sensor may function as the full level detector 1106.

FIGS. 7 and 8 illustrate an example in which the waste toner amount detector 1107 as the nearly full level sensor that detects that the waste toner box 1101 reaches the nearly full state is disposed in the waste toner collection unit 110. In the example illustrated in FIGS. 7 and 8, the nearly full level sensor 1107 as the waste toner amount detector detects whether the height of the waste toner accumulated in the waste toner box 1101 has reached a predetermined height corresponding to the predetermined amount to be used to determine the nearly full state. In this case, the waste toner amount detector (nearly full level sensor) 1107 detects that the waste toner box 1101 has reached the nearly full state by detecting that the height of the waste toner stored in the waste toner box 1101 has reached the predetermined height.

Next, display processing in which the image forming apparatus 100 according to the embodiment displays (notifies) the state (waste toner amount) of the waste toner stored in the waste toner box 1101 will be described.

Specifically, the image forming apparatus 100 displays the nearly full state (close to the full state) and the full state as guidance displays of the amount of waste toner in the waste toner box 1101. The image forming apparatus 100 adjusts a display timing (timing at which the nearly full state display is performed) at which the nearly full state is displayed after the amount of waste toner stored in the waste toner box 1101 reaches the predetermined amount corresponding to the nearly full state.

The image forming apparatus 100 presents the printing operation when the waste toner box 1101 becomes full. In order to enable smooth replacement (efficient replacement) of the waste toner box 1101 that is full, the image forming apparatus 100 performs adjustment so as to display the nearly full state a predetermined period (for example, 1 week to 10 days) before the waste toner box 1101 becomes full. In the image forming apparatus 100, a period from when the amount of waste toner in the waste toner box 1101 reaches the nearly full level to when the waste toner box becomes full varies depending on an actual usage condition. Therefore, the image forming apparatus 100 according to the embodiment performs control to display the nearly full state the predetermined period before the waste toner box 1101 is predicted to be full from the actual usage condition.

A first operation example will be described below as an example of the display processing in which the image forming apparatus 100 displays the state of the waste toner stored in the waste toner box 1101.

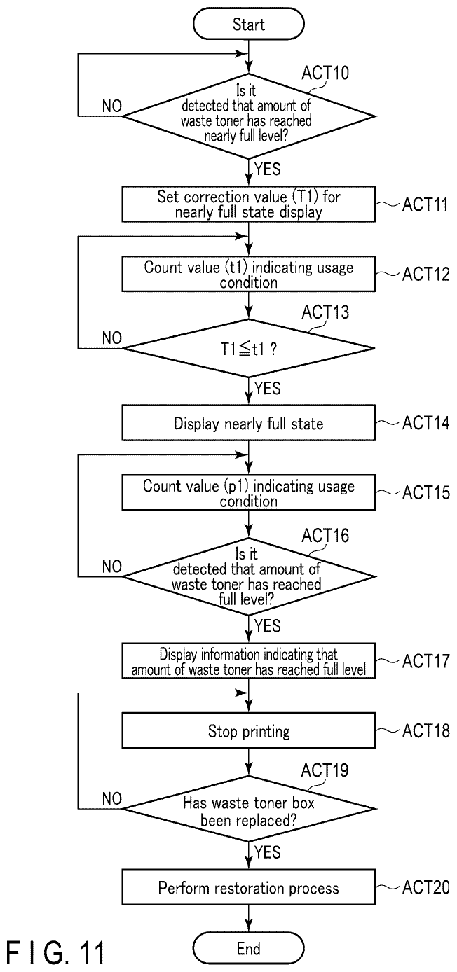

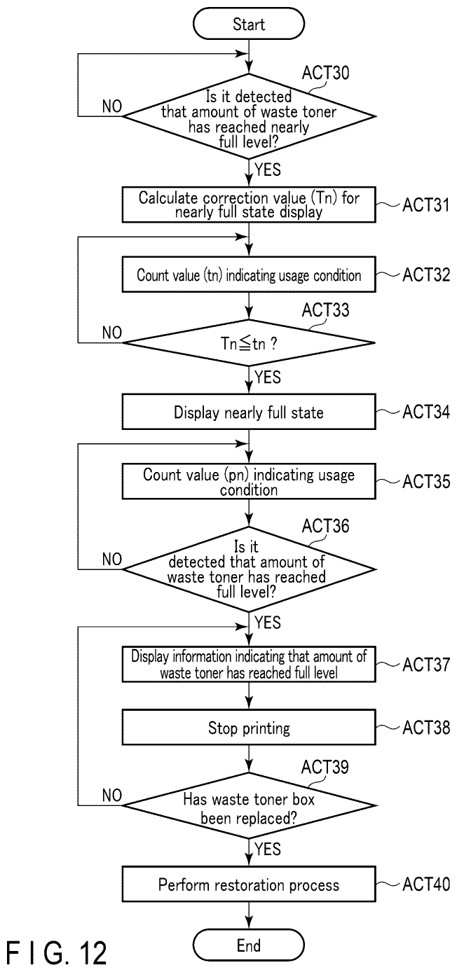

FIGS. 11 and 12 are flowcharts for explaining the first operation example in the display processing in which the image forming apparatus 100 displays the state of the waste toner in the waste toner box 1101. The first operation example illustrated in FIGS. 11 and 12 is an example of an operation of the image forming apparatus 100 including the waste toner amount detector 1107 that functions as the nearly full level sensor in the waste toner collection unit 110. That is, the image forming apparatus 100 according to the first operation example illustrated in FIGS. 11 and 12 has a function of detecting, by the waste toner amount detector 1107, that the amount of waste toner stored in the waste toner box 1101 has reached the predetermined amount corresponding to the nearly full state.

First, as the first operation example, processing by the image forming apparatus 100 in a case where the number of times of replacement of the waste toner box 1101 is 0 will be described.

FIG. 11 is a flowchart for explaining the first operation example in the image forming apparatus 100 in a case where the number of times of replacement of the waste toner box 1101 is 0.

For example, it is assumed that the number of times of replacement of the waste toner box 1101 is reset when the operation of the image forming apparatus 100 starts at a new installation location. In a case where the number of times of replacement of the waste toner box 1101 is 0, the image forming apparatus 100 executes processing as illustrated in FIG. 11 as the first operation example until the first replacement (initial replacement) of the waste toner box 1101 is performed.

In a case where the number of times of replacement of the waste toner box 1101 is 0, the image forming apparatus 100 holds, in the auxiliary storage device 124, information (n=1) indicating the first display processing for the waste toner. In this state, the processor 121 of the image forming apparatus 100 monitors whether or not the amount of waste toner in the waste toner box 1101 has reached the nearly full level according to the detection result of the waste toner amount detector 1107 as the nearly full level sensor during the operation in which the printing operation or the like is performed (ACT10).

For example, the processor 121 determines whether or not the waste toner amount detector 1107 has detected that the amount of waste toner stored in the waste toner box 1101 has reached the amount corresponding to the nearly full state. In a case where the waste toner amount detector 1107 has not detected that the amount of waste toner in the waste toner box 1101 has reached the nearly full level (ACT10, NO), the processor 121 continues monitoring whether or not the amount of waste toner in the waste toner box 1101 has reached the nearly full level according to the detection result of the waste toner amount detector 1107.

In a case where the waste toner amount detector 1107 has detected that the amount of waste toner in the waste toner box 1101 has reached the nearly full level (ACT10, YES), the processor 121 sets a correction value for the nearly full state display (ACT11). The nearly full state display is a process of causing the display unit 1161 to display information indicating that the waste toner box is nearly full (nearly full state). The correction value for the nearly full state display is set such that the display timing of the nearly full state display is set so that the waste toner box 1101 becomes full after a predetermined period (for example, after 1 week to 10 days).

In the present embodiment, the correction value for the nearly full state display for controlling the nth nearly full state display (when the number of times of replacement of the waste toner box is (n-1)) is denoted as Tn. The correction value Tn for the nearly full state display is a value indicating a display timing from when the nearly full state is detected to when the nearly full state display is actually performed. The correction value Tn for the nearly full state display is set in association with a value that indicates the usage condition of the image forming apparatus 100 and is counted after the nearly full state is detected.

In ACT11, since the number of times of replacement of the waste toner box 1101 is 0, a correction value (correction value for the nearly full state display) T1 for controlling the first nearly full state display is set. For example, the correction value T1 for the nearly full state display set in ACT11 may be the default setting value stored in the auxiliary storage device 124 or the ROM 122. In this case, in ACT11, the processor 121 sets the default setting value stored in the auxiliary storage device 124 or the ROM 122 as the correction value T1 for the nearly full state display.

In addition, the processor 121 counts a value (t1) indicating the usage condition of the image forming apparatus 100 from when the waste toner amount detector (nearly full level sensor) 1107 detects that the amount of waste toner in the waste toner box 1101 has reached the nearly full level (ACT12). The value (count value) t1 indicating the usage condition only needs to be a value counted according to the usage condition, and is a value corresponding to the correction value T1 for the nearly full state display. For example, the count value t1 indicating the usage condition may be a value regarding image forming processing, such as the number of prints, or may be an elapsed time (may be elapsed days). When the correction value T1 for the nearly full state display is set corresponding to the number of prints, the processor 121 counts the number of prints as the count value t1 indicating the usage condition after the amount of waste toner in the waste toner box 1101 reaches the nearly full level.

When the processor 121 counts the usage condition after the amount of waste toner in the waste toner box 1101 reaches the nearly full level, the processor 121 determines whether or not the count value t1 is greater than or equal to the correction value T1 for the nearly full state display (ACT13). In a case where the count value t1 is greater than or equal to the correction value T1 for the nearly full state display (ACT13, YES), the processor 121 causes the display unit 1161 to display the information indicating that the waste toner box 1101 is nearly full (nearly full state) (ACT14).

When the display unit 1161 displays the nearly full state, the processor 121 counts a value (p1) indicating the usage condition of the image forming apparatus 100 from when the nearly full state is displayed to when the waste toner box 1101 becomes full (ACT15). That is, the processor 121 counts the value p1 indicating the usage condition of the image forming apparatus 100 from when the display unit 1161 displays the nearly full state to when the waste toner box 1101 becomes full. The value (count value) p1 indicating the usage condition may be any value as long as the value is counted from when the nearly full state is displayed to when the waste toner box 1101 becomes full. For example, the count value p1 may be a value regarding image forming processing, such as the number of prints, or may be an elapsed time from when the nearly full state is displayed to when the waste toner box 1101 becomes full.

In addition, the processor 121 stores the value (count value) p1 that indicates the usage condition of the image forming apparatus 100 and is counted until the waste toner box 1101 becomes full, in a memory such as the auxiliary storage device 124 as needed. As a result, when the waste toner box 1101 becomes full, the auxiliary storage device 124 stores a count value pn indicating the usage condition of the image forming apparatus 100 from when the display unit 1161 displays the nearly full state to when the waste toner box 1101 becomes full.

After the display unit 1161 displays the nearly full state, the processor 121 monitors whether or not the amount of waste toner in the waste toner box has reached the full level based on the detection result of the full level detector 1106 (ACT16).

In a case where the processor 121 detects that the amount of waste toner in the waste toner box 1101 has reached the full level (ACT16, NO), the processor 121 continues counting the value p1 indicating the usage condition. However, in a case where the waste toner box 1101 is replaced in a period from when the nearly full state is displayed by the display unit 1161 to when the amount of waste toner in the waste toner box 1101 reaches the full level, the processor 121 proceeds to ACT20 and executes a restoration process described later.

In a case where the processor 121 detects that the amount of waste toner in the waste toner box 1101 has reached the full level (ACT16, YES), the processor 121 causes the display unit 1161 to display information indicating that the amount of waste toner stored in the waste toner box 1101 has reached the full level (or guidance on replacement of the waste toner box) (ACT17). Further, the processor 121 causes the display unit 1161 to display information indicating that the waste toner box 1101 is full, and enters an operation stop state (execution of printing disabled) (ACT18). In this state, the processor 121 waits for replacement of the waste toner box 1101.

In a case where the waste toner box 1101 has been replaced (ACT19, YES), the processor 121 executes the restoration process to make the printing operation executable (ACT20). In the restoration process, the processor 121 confirms that the waste toner box 1101 is normally set. When the processor 121 confirms that the waste toner box 1101 has been replaced normally, the number of times of replacement of the waste toner box is set to 1, and various count values and the like are reset.

Next, the first operation example as the display processing by the image forming apparatus 100 in a case where the number of times of replacement of the waste toner box 1101 is greater than or equal to 1 will be described.

FIG. 12 is a flowchart for explaining the first operation example in the image forming apparatus 100 in a case where the number of times of replacement of the waste toner box 1101 is greater than or equal to 1.

The processor 121 of the image forming apparatus 100 updates the number of times of replacement of the waste toner box 1101 when the restoration is performed after the replacement of the waste toner box 1101. When updating the number of times of replacement of the waste toner box 1101, the processor 121 updates information n indicating the number of times of display processing for waste toner according to the number of times of replacement. For example, when updating the number of times of replacement of the waste toner box 1101 to 1, the processor 121 holds information (n=2) indicating that the second display processing for the waste toner is performed in the auxiliary storage device 124.

When the waste toner box 1101 is replaced and the restoration is performed, the processor 121 of the image forming apparatus 100 monitors whether or not the amount of waste toner in the waste toner box 1101 has reached the nearly full level (ACT30). The processor 121 monitors whether or not the waste toner amount detector 1107 as the nearly full level sensor has detected that the amount of waste toner stored in the waste toner box 1101 has reached the predetermined amount corresponding to the nearly full state (ACT30). In a case where the processor 121 does not detect that the amount of waste toner in the waste toner box 1101 has reached the nearly full level (ACT30, NO), the processor 121 continues monitoring whether or not the amount of waste toner in the waste toner box 1101 has reached the nearly full level.

In a case where the processor 121 detects that the amount of waste toner in the waste toner box 1101 has reached the nearly full level (ACT30, YES), the processor 121 calculates a correction value Tn for the nth nearly full state display (ACT31). The correction value Tn for the nth nearly full state display is adjusted so that the waste toner box 1101 becomes full after a predetermined period (for example, after 1 week to 10 days). The processor 121 calculates the correction value Tn for the nearly full state display based on a count value pn-1 (or pn-1 to p1) indicating the usage condition of the image forming apparatus 100. The processor 121 stores (sets), in the memory such as the auxiliary storage device 124, the correction value Tn for the nearly full state display calculated based on the count value indicating the usage condition of the image forming apparatus 100.

For example, the processor 121 calculates the correction value Tn for the nearly full state display by adjusting (correcting) the correction value Tn-1 for the previous nearly full state display based on the count value pn-1 (or pn-1 to p1) indicating the usage condition of the image forming apparatus 100 counted from when the previous nearly full state display is performed to when the waste toner box 1101 becomes full.

As a specific example, the processor 121 calculates the correction value Tn for the nearly full state display according to Tn=Tn−1+k. In this case, k is an adjustment value for the correction value Tn-1 for the previous nearly full state display for calculating the correction value Tn for the nearly full state display. The adjustment value k is set based on the count value pn-1 (or pn-1 to p1) indicating the usage condition of the image forming apparatus 100 counted from when the nearly full state display is performed to when the waste toner box 1101 becomes full.

For example, when the count value indicating the usage condition is the number of prints, the correction value Tn for the nearly full state display is calculated by adjusting (correcting) the correction value Tn-1 for the previous nearly full state display with the number of prints as the count value pn-1. When the count value indicating the usage condition is the elapsed time, the correction value Tn for the nearly full state display is calculated by adjusting (correcting) the correction value Tn-1 for the previous nearly full state display with the elapsed time as the count value pn-1.

The processor 121 may calculate the correction value Tn for the nearly full state display by adjusting the correction value T1, which is the default setting value, with the count value pn-1 (or pn-1 to p1), instead of the correction value Tn-1 for the previous nearly full state display.

When detecting that the amount of waste toner in the waste toner box 1101 has reached the nearly full level, the processor 121 counts a value (tn) indicating the usage condition of the image forming apparatus 100 from when the amount of waste toner in the waste toner box 1101 has reached the nearly full level (ACT32). The count value tn corresponds to the correction value Tn for nearly full state display. For example, when the correction value Tn for the nearly full state display is set corresponding to the number of prints, the processor 121 counts the number of prints as the value tn indicating the usage condition from when the amount of waste toner in the waste toner box 1101 has reached the nearly full level.

When the processor 121 counts the usage condition after the amount of waste toner in the waste toner box 1101 reaches the nearly full level, the processor 121 determines whether or not the count value tn is greater than or equal to the correction value Tn for the nearly full state display (ACT33). In a case where the count value tn is greater than or equal to the correction value Tn for the nearly full state display (ACT33, YES), the processor 121 causes the display unit 1161 to display the information indicating that the waste toner box 1101 is nearly full (nearly full state) (ACT34).

When the display unit 1161 displays the nearly full state, the processor 121 counts the value (pn) indicating the usage condition of the image forming apparatus 100 from when the nearly full state is displayed (ACT35). That is, the processor 121 counts the value pn indicating the usage condition of the image forming apparatus 100 from when the display unit 1161 displays the nearly full state to when the waste toner box 1101 becomes full. The value (count value) pn indicating the usage condition is a value for setting the above-described adjustment value k. The count value pn may be, for example, a value regarding image formation, such as the number of prints, or may be the elapsed time.

In addition, the processor 121 stores the value (count value) pn that indicates the usage condition of the image forming apparatus 100 and is counted until the waste toner box 1101 becomes full, in the memory such as the auxiliary storage device 124 as needed. As a result, when the waste toner box 1101 becomes full, the auxiliary storage device 124 stores the count value pn indicating the usage condition of the image forming apparatus 100 from when the display unit 1161 displays the nearly full state to when the waste toner box 1101 becomes full.

After the display unit 1161 displays the nearly full state, the processor 121 monitors whether or not the amount of waste toner in the waste toner box has reached the full level based on the detection result of the full level detector 1106 (ACT36).

In a case where the processor 121 detects that the amount of waste toner stored in the waste toner box 1101 has reached the full level (ACT36, NO), the processor 121 continues counting the value pn indicating the usage condition. However, in a case where the waste toner box 1101 is replaced in a period from when the nearly full state is displayed by the display unit 1161 to when the amount of waste toner in the waste toner box 1101 reaches the full level, the processor 121 proceeds to ACT40 and executes the restoration process described later.

In a case where the processor 121 detects that the amount of waste toner stored in the waste toner box 1101 has reached the full level (ACT36, YES), the processor causes the display unit 1161 to display the information indicating that the amount of waste toner stored in the waste toner box 1101 has reached the full level (or guidance on replacement of the waste toner box) (ACT37). Further, the processor 121 causes the display unit 1161 to display information indicating that the waste toner box 1101 is full, and enters the operation stop state (execution of printing disabled) (ACT38). In this state, the processor 121 waits for replacement of the waste toner box 1101.

In a case where the waste toner box 1101 has been replaced (ACT39, YES), the processor 121 executes the restoration process to make the printing operation executable (ACT40). In the restoration process, the processor 121 confirms that the waste toner box 1101 is normally set. When the processor 121 confirms that the waste toner box 1101 has been replaced normally, the number of times of replacement of the waste toner box is set to n, and the various count values and the like are reset.

As described above, the image forming apparatus according to the first operation example acquires, as the value indicating the usage condition of the image forming apparatus, a value indicating the usage condition from when the nearly full state display was performed in the past to when the waste toner box 1101 becomes full. The image forming apparatus calculates a correction value for the nearly full state display based on the value indicating the usage condition in the past. The image forming apparatus uses the correction value for the nearly full state display to control a display timing from when the nearly full state is detected to when the display unit displays the nearly full state.

As a result, according to the first operation example, the image forming apparatus can cause the display unit to display the information indicating that the waste toner box is nearly full at an appropriate timing adjusted according to the actual usage condition. That is, the image forming apparatus according to the first operation example can perform the nearly full state display at a timing so that the waste toner box becomes full after a predetermined period (for example, 1 week to 10 days) according to the actual usage condition. As a result, the user or the service person can immediately replace the waste toner box when the waste toner box becomes full, and can prepare for replacement of the waste toner box without waste.

Note that, as a modification of the first operation example described above, the image forming apparatus 100 may acquire information corresponding to the count values pn-1 to p1 indicating the usage condition of the image forming apparatus from the external apparatus and calculate (adjust) the correction value for the nearly full state display. That is, as processing in ACT31, the image forming apparatus 100 according to the modification of the first operation example calculates the correction value for the nearly full state display based on the information acquired from the external apparatus.

The information corresponding to the count values pn-1 to p1 indicating the usage condition of the image forming apparatus and acquired from the external apparatus is, for example, a value indicating a usage condition in the other image forming apparatus. Further, the external apparatus may be any apparatus that communicates via an interface such as the communication interface 125 included in the image forming apparatus 100. For example, the external apparatus may be the other image forming apparatus 100 connected to the corporate network 500, or may be the server apparatus 300.

For example, it is often assumed that the plurality of image forming apparatuses connected to the corporate network 500 are in similar use environments. In such an environment, each of the image forming apparatuses 100 can calculate a correction value for nearly full state display based on a value indicating a usage condition acquired from the other image forming apparatus 100. Also in this case, each of the image forming apparatuses can control a display timing of the nearly full state display according to the usage condition of the other image forming apparatus in the similar use environment, and can perform the nearly full state display at an appropriate timing.

In addition, the image forming apparatus 100 may directly acquire the value indicating the usage condition of the other image forming apparatus from the other image forming apparatus. In this case, the image forming apparatus 100 sets the other image forming apparatus (for example, the other image forming apparatus connected to the same corporate network 500) assumed to be in the similar environment to that of the image forming apparatus 100. The image forming apparatus 100 acquires the value indicating the usage condition of the other image forming apparatus by communicating with the other image forming apparatus set to be in the similar environment.

In addition, the image forming apparatus 100 may acquire the value indicating the usage condition of the other image forming apparatus from the server apparatus 300. In this case, the image forming apparatus 100 constructs a printing system so that the image forming apparatus 100 can acquire, from the server apparatus 300, the value indicating the usage condition of the other image forming apparatus in the similar environment. For example, the server apparatus 300 collects a value indicating a usage condition from each image forming apparatus connected to each corporate network 500. In response to a request from a specific image forming apparatus, the server apparatus 300 provides, to the specific image forming apparatus 100, a value indicating a usage condition acquired from another image forming apparatus (for example, the other image forming apparatus connected to the same corporate network) in a similar environment to that of the specific image forming apparatus. As a result, the image forming apparatus 100 can acquire the value indicating the usage condition of the other image forming apparatus in the similar environment from the server apparatus 300.

Next, a second operation example as display processing for waste toner in the waste toner box 1101 by the image forming apparatus 100 according to the embodiment will be described.

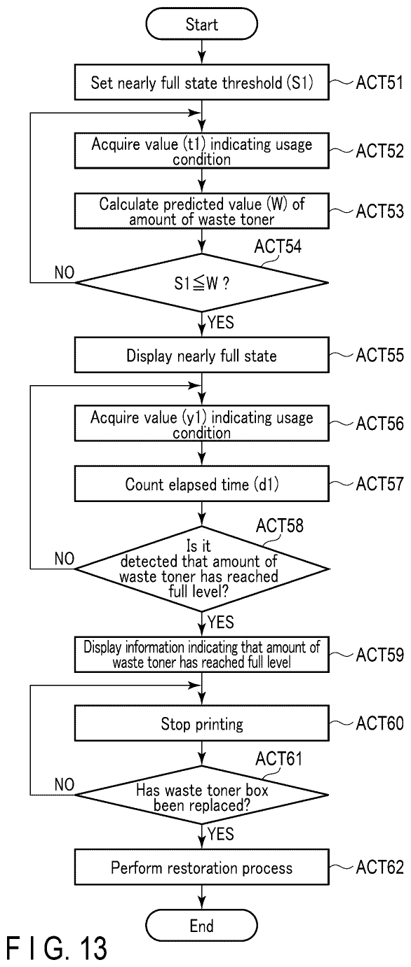

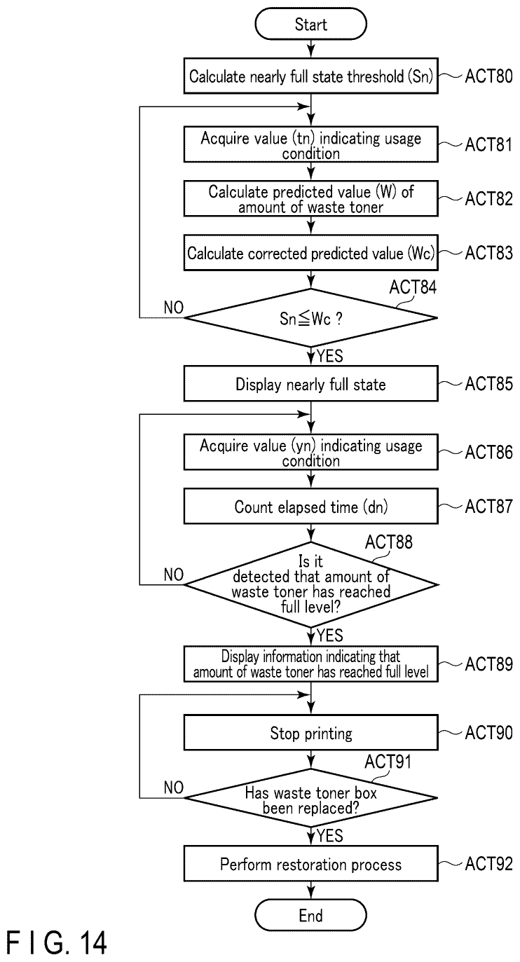

FIGS. 13 and 14 are flowcharts for explaining the second operation example in display processing for waste toner in the waste toner box 1101 by the image forming apparatus 100.

The second operation example illustrated in FIGS. 13 and 14 is an operation example in which the image forming apparatus 100 calculates a predicted value of the amount of waste toner in the waste toner box 1101 and controls the nearly full state display based on the calculated predicted value of the amount of waste toner. It is assumed that the second operation example illustrated in FIGS. 13 and 14 is display processing for waste toner by the image forming apparatus 100 not including the waste toner amount detector 1107.

First, as the second operation example, processing by the image forming apparatus 100 in a case where the number of times of replacement of the waste toner box 1101 is 0 will be described.

FIG. 13 is a flowchart for explaining the second operation example in the image forming apparatus 100 in a case where the number of times of replacement of the waste toner box 1101 is 0.

In a case where the number of times of replacement of the waste toner box 1101 is 0, the processor 121 of the image forming apparatus 100 holds, in the auxiliary storage device 124, information (n=1) indicating the first display processing for the waste toner. In this case, the processor 121 sets a threshold (nearly full state threshold) S1 for adjusting a display timing at which the first nearly full state display is performed (ACT51).

In this case, the nearly full state threshold is set to be the amount of waste toner of which the waste toner box 1101 is estimated to be full after a predetermined period (for example, after 1 week to 10 days). That is, the nearly full state threshold is set such that the waste toner box 1101 becomes full after the predetermined period from when the predicted value of the amount of waste toner calculated from values indicating various usage conditions reaches the nearly full state threshold. When the number of times of replacement of the waste toner box 1101 is 0 (when the display processing is the first nearly full state display), the processor 121 sets the nearly full state threshold S1 as a default setting value stored in advance in the auxiliary storage device 124 or the ROM 122.

In order to predict the amount of waste toner in the waste toner box 1101, the processor 121 acquires (collects) various values (t1) indicating the usage condition of the image forming apparatus 100 from the start of the operation (ACT52). However, it is assumed that the waste toner box 1101 is empty at the start of the operation in the image forming apparatus 100.

In the second operation example, it is assumed that the values t1 indicating the usage condition include various values (parameters) for calculating a predicted value of the amount of waste toner in the waste toner box 1101. That is, the processor 121 acquires (collects) the various values t1 for calculating the predicted value of the amount of waste toner stored in the waste toner box 1101. For example, the values t1 indicating the usage condition include values such as a printing rate, the number of prints, the number of times the photosensitive drums are started and stopped, and an estimated value of the amount of toner to be consumed for a non-printing operation such as alignment control. The predicted value of the amount of waste toner is calculated from the above-described various values t1 using a predetermined calculation formula.

When collecting the various values t1 indicating the usage condition, the processor 121 calculates a predicted value (W) of the amount of waste toner in the waste toner box 1101 based on the collected various values t1 (ACT53). For example, the processor 121 calculates the predicted value W of the waste toner from the various values (the printing rate, the number of prints, the number of times the photosensitive drums are started and stopped, and the estimated value of the amount of toner to be consumed for the non-printing operation such as the alignment control) indicating the usage condition using the predetermined calculation formula.

Note that the calculation formula (calculation formula for the amount of waste toner) for calculating the predicted value of the waste toner may be any formula as long as the predicted value of the amount of waste toner can be calculated from information obtained from the image forming apparatus 100 (being operated) in operation. For example, the calculation formula for the amount of waste toner is set for each model and specification of the image forming apparatus 100, and is designed using a coefficient or the like set from experimentally obtained data.

After calculating the predicted value W of the amount of waste toner, the processor 121 determines whether or not the predicted value W is greater than or equal to the nearly full state threshold S1 (ACT54).

In a case where the predicted value W of the amount of waste toner is greater than or equal to the nearly full state threshold S1 (ACT54, YES), the processor 121 causes the display unit 1161 to display the information indicating that the waste toner box 1101 is nearly full (nearly full state) (ACT55).

When the display unit 1161 displays the nearly full state, the processor 121 acquires (collects) a value (y1) indicating the usage condition of the image forming apparatus 100 after the nearly full state is displayed (ACT56). The processor 121 continues collecting the value (y1) indicating the usage condition of the image forming apparatus 100 from when the nearly full state is displayed to when the waste toner box 1101 becomes full. Similarly to the values t1 indicating the usage condition described above, the value y1 indicating the usage condition of the image forming apparatus 100 may include values such as the printing rate, the number of prints, the number of times the photosensitive drums are started and stopped, and an estimated value of the amount of toner to be consumed for the non-printing operation such as the alignment control.

Further, the processor 121 uses the RTC 126 to count an elapsed time (d1) from when the display unit 1161 displays the nearly full state (ACT57). That is, until the waste toner box 1101 becomes full, the processor 121 counts the elapsed time from when the display unit 1161 displays the nearly full state.

In addition, the processor 121 stores the value y1 indicating the usage condition and the elapsed time d1 in the auxiliary storage device 124 or the like as needed. As a result, when the waste toner box 1101 becomes full, y1 and d1 stored in the auxiliary storage device 124 are count values indicating the usage condition of the image forming apparatus 100 from when the nearly full state is displayed for the first time to when the waste toner box 1101 becomes full.

After the display unit 1161 displays the nearly full state, the processor 121 determines whether or not the amount of waste toner in the waste toner box 1101 has reached to the full level (ACT58). The processor 121 monitors the detection result of the full level detector 1106 to determine whether or not the waste toner box 1101 is full.

In a case where the processor 121 does not detect that the amount of waste toner stored in the waste toner box 1101 has reached the full level (ACT58, NO), the processor 121 continues collecting the value y1 indicating the usage condition and counting the elapsed time (d1). However, in a case where the waste toner box 1101 is replaced in a period from when the nearly full state is displayed by the display unit 1161 to when the amount of waste toner in the waste toner box 1101 reaches the full level, the processor 121 proceeds to ACT62 and executes the restoration process.

In a case where the processor 121 detects that the amount of waste toner stored in the waste toner box 1101 has reached the full level (ACT58, YES), the processor 121 causes the display unit 1161 to display the information indicating that the amount of waste toner stored in the waste toner box 1101 has reached the full level (or guidance on replacement of the waste toner box) (ACT59). Further, the processor 121 causes the display unit 1161 to display the information indicating that the waste toner box 1101 is full, and stops the printing operation (execution of printing operation disabled) (ACT60). In this state, the processor 121 waits for replacement of the waste toner box 1101.

In a case where the waste toner box 1101 has been replaced (ACT61, YES), the processor 121 executes the restoration process to make the printing operation executable (ACT62). In the restoration process, the processor 121 confirms that the waste toner box 1101 is normally set. When the processor 121 confirms that the waste toner box 1101 has been replaced normally, the number of times of replacement of the waste toner box is set to 1, and the various count values and the like are reset.

Next, the second operation example as display processing for waste toner by the image forming apparatus 100 in a case where the number of times of replacement of the waste toner box 1101 is greater than or equal to 1 will be described.

FIG. 14 is a flowchart for explaining the second operation example in the image forming apparatus 100 in a case where the number of times of replacement of the waste toner box 1101 is greater than or equal to 1.

The processor 121 of the image forming apparatus 100 updates the number of times of replacement of the waste toner box 1101 when the restoration is performed after the replacement of the waste toner box 1101. When updating the number of times of replacement of the waste toner box 1101, the processor 121 updates the information n indicating the number of times of display processing for waste toner according to the number of times of replacement. For example, when updating the number of times of replacement of the waste toner box 1101 to 1, the processor 121 holds the information (n=2) indicating that the second display processing for waste toner is performed in the auxiliary storage device 124.

When the waste toner box 1101 is replaced and the restoration is performed, the processor 121 calculates a nearly full state threshold Sn for adjusting a display timing for performing the nth nearly full state display (ACT51). The nearly full state threshold Sn is adjusted so as to be the amount of waste toner of which the waste toner box 1101 is estimated to be full after a predetermined period (for example, after 1 week to 10 days). The processor 121 calculates the nearly full state threshold Sn based on values yn-1 to y1 indicating the usage condition of the image forming apparatus 100 and/or elapsed times dn-1 to d1. After calculating the nearly full state threshold Sn, the processor 121 stores (sets) the calculated nearly full state threshold Sn in the memory such as the auxiliary storage device 124.

For example, the processor 121 calculates the nearly full state threshold Sn by adjusting (correcting) the previous nearly full state threshold Sn-1 based on the value yn-1 indicating the usage condition and/or the elapsed time dn-1 from when the previous nearly full display is performed to when the waste toner box 1101 becomes full. In addition, if n>2, the processor 121 may calculate the nearly full state threshold Sn by adjusting (correcting) the previous nearly full state threshold Sn-1 based on the values yn-1 to y1 indicating the usage condition and/or the elapsed times dn-1 to d1.

As a specific example, the processor 121 calculates the nearly full state threshold Sn according to Sn=Sn-1+k. Here, k is an adjustment value for adjusting (correcting) the previous nearly full state threshold Sn-1 to calculate the nearly full state threshold Sn. The adjustment value k is set based on the values yn-1 to y1 that indicate the usage condition of the image forming apparatus 100 and are counted from when the nearly full state display is performed to when the waste toner box 1101 becomes full, and/or the elapsed times dn-1 to d1 from when the nearly full state display is performed to when the waste toner box 1101 becomes full.

Further, the adjustment value k for calculating the nearly full state threshold may be set based on any one value included in the elapsed times dn-1 to d1 or the values yn-1 to y1 indicating the usage condition. For example, the processor 121 may calculate the nearly full state threshold Sn by adjusting the nearly full state threshold Sn-1 based on the number of prints (image formation) included in the value yn-1 indicating the usage condition. Further, the processor 121 may calculate the nearly full state threshold Sn by adjusting the nearly full state threshold Sn-1 based on the elapsed time dn-1.

Note that the processor 121 may calculate the nearly full state threshold Sn by adjusting the nearly full state threshold S1, which is a default setting value, based on the values yn-1 to y and/or the elapsed times dn-1 to d1.

When the waste toner box is replaced and the restoration is performed (operable), the processor 121 acquires (collects) various values (tn) indicating the usage condition of the image forming apparatus 100 after the restoration (ACT52). In the second operation example, the values tn indicating the usage condition include various values (parameters) for calculating the predicted value of the amount of waste toner in the waste toner box 1101 as described above.

When collecting the various values tn indicating the usage condition, the processor 121 calculates the predicted value (W) of the amount of waste toner in the waste toner box 1101 based on the collected various values t1 (ACT53). For example, the processor 121 calculates the predicted value W of the amount of waste toner from the various values tn indicating the usage condition using the above-described calculation formula for the amount of waste toner.

After calculating the predicted value W of the amount of waste toner, the processor 121 further corrects the calculated predicted value W (ACT83). The processor 121 calculates a predicted value (Wc) obtained by correcting the predicted value W of the amount of waste toner based on the values yn-1 to y1 indicating the usage condition of the image forming apparatus 100 and/or the elapsed times dn-1 to d1.

For example, the processor 121 calculates a correction amount L for the predicted value W of the amount of waste toner based on the value yn-1 indicating the usage condition of the image forming apparatus 100 and/or the elapsed time dn-1 from when the previous nearly full state display is performed to when the amount of waste toner in the waste toner box 1101 reaches the full level. After calculating the correction amount L, the processor 121 calculates the predicted value Wc of the amount of waste toner after correction according to Wc=W+L. When n>2, the processor 121 may calculate the correction amount L based on the values yn-1 to y1 indicating the usage condition and/or the elapsed times dn-1 to d1, and calculate the predicted value Wc of the corrected amount of waste toner.

After calculating the corrected predicted value Wc of the amount of waste toner, the processor 121 determines whether or not the corrected predicted value Wc is greater than or equal to the nearly full state threshold Sn (ACT84). Note that the image forming apparatus 100 may omit the process of correcting the predicted value W of the amount of waste toner in ACT83. In a case where the correction of the amount of waste toner in ACT83 is omitted, the processor 121 may determine whether or not the predicted value W of the amount of waste toner is greater than or equal to the nearly full state threshold Sn in ACT84.

In a case where the predicted value Wc of the corrected amount of waste toner is greater than or equal to the nearly full state threshold Sn (ACT84, YES), the processor 121 causes the display unit 1161 to display the information indicating that the waste toner box 1101 is nearly full (nearly full state) (ACT85).

When the display unit 1161 displays the nearly full state, the processor 121 acquires (collects) the value (yn) indicating the usage condition of the image forming apparatus 100 after the nearly full state is displayed (ACT86). The processor 121 continues collecting the value yn indicating the usage condition of the image forming apparatus 100 from when the nearly full state is displayed to when the waste toner box 1101 becomes full.

Further, the processor 121 counts an elapsed time (dn) by using the RTC 126 from when the display unit 1161 displays the nearly full state (ACT87). That is, until the waste toner box 1101 becomes full, the processor 121 counts the elapsed time dn from when the display unit 1161 displays the nearly full state.

In addition, the processor 121 stores the value yn indicating the usage condition and the elapsed time dn in the auxiliary storage device 124 or the like as needed. As a result, when the waste toner box 1101 becomes full, yn and dn stored in the auxiliary storage device 124 are count values indicating the usage condition of the image forming apparatus 100 from when the nearly full state is displayed to when the waste toner box 1101 becomes full.

After the display unit 1161 displays the nearly full state, the processor 121 determines whether or not the waste toner box 1101 is full (ACT88). The processor 121 monitors the detection result of the full level detector 1106 to determine whether or not the waste toner box 1101 is full.

In a case where the processor 121 does not detect that the amount of waste toner stored in the waste toner box 1101 has reached the full level (ACT88, NO), the processor 121 continues collecting the value yn indicating the usage condition and counting the elapsed time dn. However, in a case where the waste toner box 1101 is replaced in a period from when the nearly full state is displayed by the display unit 1161 to when the amount of waste toner in the waste toner box 1101 reaches the full level, the processor 121 proceeds to ACT92 and executes the restoration process.

In a case where the processor 121 detects that the amount of waste toner stored in the waste toner box 1101 has reached the full level (ACT88, YES), the processor 121 causes the display unit 1161 to display the information indicating that the amount of waste toner stored in the waste toner box 1101 has reached the full level (or guidance on replacement of the waste toner box) (ACT89). Further, the processor 121 causes the display unit 1161 to display the information indicating that the waste toner box 1101 is full, and enters the operation stop (printing is not executable) state (ACT90). In this state, the processor 121 waits for replacement of the waste toner box 1101.

In a case where the waste toner box 1101 has been replaced (ACT91, YES), the processor 121 executes the restoration process to make the printing operation executable (ACT92). In the restoration process, the processor 121 confirms that the waste toner box 1101 is normally set. When the processor 121 confirms that the waste toner box 1101 has been replaced normally, the number of times of replacement of the waste toner box is set to n, and the various count values and the like are reset.

As described above, the image forming apparatus according to the second operation example acquires, as the value indicating the usage condition of the image forming apparatus, a value indicating the usage condition from when the nearly full state display was performed in the past to when the waste toner box 1101 becomes full. The image forming apparatus calculates the nearly full state threshold based on the value indicating the usage condition from when the nearly full state display was performed in the past to when the waste toner box 1101 becomes full. The image forming apparatus displays the nearly full state when the predicted value of the amount of waste toner calculated from the various values indicating the usage condition after the replacement of the waste toner box reaches the nearly full state threshold.

As a result, according to the second operation example, the image forming apparatus can calculate the predicted value of the amount of waste toner and display the nearly full state at a timing adjusted according to the actual usage condition. That is, even if the image forming apparatus does not include the nearly full level sensor, the image forming apparatus can perform the nearly full state display at a display timing so that the waste toner box becomes full after a predetermined period (for example, after 1 week to 10 days). As a result, the user or the service person can immediately replace the waste toner box when the waste toner box becomes full, and can prepare for replacement of the waste toner box without waste.

Note that, as a modification of the second operation example described above, the image forming apparatus 100 may acquire information corresponding to the values yn-1 to y1 indicating the usage condition and the elapsed times dn-1 to d1 from the external apparatus and calculate the nearly full state threshold. The information corresponding to the values yn-1 to y1 indicating the usage condition of the image forming apparatus and the elapsed times dn-1 to d1 is, for example, a value indicating a usage condition in the other image forming apparatus. Further, the external apparatus may be any apparatus that communicates via the communication interface 125 of the image forming apparatus 100. For example, the external apparatus may be the other image forming apparatus 100 connected to the corporate network 500, or may be the server apparatus 300.

As the processing in ACT80, the image forming apparatus 100 according to the modification of the second operation example calculates the nearly full state threshold based on information (for example, a value indicating the usage condition of the other image forming apparatus 100) acquired from the external apparatus. In addition, the image forming apparatus 100 according to the modification of the second operation example may correct the predicted value of the amount of waste toner based on the information (for example, the value indicating the usage condition of the other image forming apparatus) acquired from the external apparatus as the processing in ACT83.

As described in the first operation example described above, it is often assumed that a plurality of image forming apparatuses connected to the corporate network 500 are in the similar use environments. In such an environment, each of the image forming apparatuses 100 can calculate the nearly full state threshold based on a value indicating a usage condition acquired from the other image forming apparatus 100. Also in this case, the image forming apparatus 100 can adjust the display timing of the nearly full state display according to the usage condition of the other image forming apparatus in the similar use environment to that of the image forming apparatus 100.

For example, the image forming apparatus 100 directly acquires the value indicating the usage condition of the other image forming apparatus assumed to be in the similar environment from the other image forming apparatus. In this case, the image forming apparatus 100 sets the other image forming apparatus (for example, the other image forming apparatus connected to the same corporate network 500) assumed to be in the similar environment to that of the image forming apparatus 100. The image forming apparatus 100 can acquire the value indicating the usage condition of the other image forming apparatus by communicating with the other image forming apparatus set to be in the similar environment to that of the image forming apparatus 100.

In addition, the image forming apparatus 100 may acquire the value indicating the usage condition of the other image forming apparatus from the server apparatus 300. In this case, the image forming apparatus 100 constructs a printing system so that the image forming apparatus 100 can acquire, from the server apparatus 300, the value indicating the usage condition of the other image forming apparatus assumed to be in the similar environment. For example, the server apparatus 300 collects a value indicating a usage condition from each image forming apparatus connected to each corporate network 500. In response to a request from a specific image forming apparatus, the server apparatus 300 provides, to the specific image forming apparatus 100, a value indicating a usage condition acquired from another image forming apparatus (for example, the other image forming apparatus connected to the same corporate network) in a similar environment to that of the specific image forming apparatus. As a result, the image forming apparatus 100 can acquire the value indicating the usage condition of the other image forming apparatus in the similar environment from the server apparatus 300.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image forming unit that forms an image using toner;
a collection unit that collects, in a storage unit, waste toner generated in image forming processing by the image forming unit;
a full level detector that detects that the storage unit is full;
a display unit that displays information indicating that the storage unit is nearly full; and
a processor that adjusts a display timing at which the display unit displays the information indicating that the storage unit is nearly full so that the storage unit becomes full after a predetermined period.

2. The image forming apparatus according to claim 1, further comprising
a memory that stores a count value indicating a usage condition of the image forming apparatus from when the display unit displays the information indicating that the storage unit is nearly full to when the full level detector detects that the storage unit is full, wherein
the processor adjusts the display timing based on the count value stored in the memory.

3. The image forming apparatus according to claim 2, further comprising
a nearly full level sensor that detects that the waste toner stored in the storage unit has reached a predetermined amount corresponding to a nearly full state, wherein
the processor calculates, based on the count value stored in the memory, a correction value for nearly full state display indicating a display timing from when the nearly full level sensor detects that the waste toner stored in the storage unit has reached the predetermined amount to when the display unit displays the information indicating that the storage unit is nearly full, and causes the display unit to display the information indicating that the storage unit is nearly full at the display timing indicated by the correction value for the nearly full state display.

4. The image forming apparatus according to claim 3, wherein
the processor causes the display unit to display the information indicating that the storage unit is nearly full when a value that indicates a usage condition of the image forming apparatus and is counted from when the nearly full level sensor detects that the waste toner stored in the storage unit has reached the predetermined amount reaches the correction value for the nearly full state display.

5. The image forming apparatus according to claim 3, wherein
the processor calculates the correction value for the nearly full state display by adding an adjustment value based on the count value stored in the memory to a correction value for previous nearly full state display.

6. The image forming apparatus according to claim 5, wherein
the count value is a number of images formed by the image forming unit and counted from when the display unit displays the information indicating that the storage unit is nearly full to when the full level detector detects that the storage unit is full.

7. The image forming apparatus according to claim 5, wherein
the count value is an elapsed time counted from when the display unit displays the information indicating that the storage unit is nearly full to when the full level detector detects that the storage unit is full.

8. The image forming apparatus according to claim 2, wherein
the processor calculates a nearly full state threshold to be adjusted based on the count value stored in the memory, and causes the display unit to display the information indicating that the storage unit is nearly full when a predicted value of an amount of the waste toner calculated based on a value indicating a usage condition of the image forming apparatus after replacement of the storage unit reaches the nearly full state threshold.

9. The image forming apparatus according to claim 8, wherein
the processor calculates the nearly full state threshold by adding an adjustment value based on the count value stored in the memory to a previous nearly full state threshold.

10. The image forming apparatus according to claim 8, wherein
the processor corrects the predicted value of the amount of the waste toner based on the count value stored in the memory, and causes the display unit to display the information indicating that the storage unit is nearly full when the corrected predicted value of the amount of the waste toner reaches the nearly full state threshold.

11. The image forming apparatus according to claim 10, wherein
the processor corrects the predicted value of the amount of the waste toner by adding a correction value for the predicted value of the amount of the waste toner calculated based on the count value stored in the memory to the predicted value of the amount of the waste toner.

12. The image forming apparatus according to claim 8, wherein
the count value includes a number of images formed by the image forming unit and counted from when the display unit displays the information indicating that the storage unit is nearly full to when the full level detector detects that the storage unit is full.

13. The image forming apparatus according to claim 8, wherein
the count value is an elapsed time counted from when the display unit displays the information indicating that the storage unit is nearly full to when the full level detector detects that the storage unit is full.

14. The image forming apparatus according to claim 1, further comprising
an interface that communicates with an external apparatus, wherein
the processor acquires, from the external apparatus communicating with the interface, information corresponding to a count value indicating a usage condition of the image forming apparatus from when the display unit displays the information indicating that the storage unit is nearly full to when the full level detector detects that the storage unit is full, and adjusts the display timing based on the information acquired from the external apparatus.

15. The image forming apparatus according to claim 14, wherein
the interface is a communication interface that communicates with another image forming apparatus, and
the processor acquires a count value indicating a usage condition in the other image forming apparatus from the other image forming apparatus as information corresponding to the count value.

16. The image forming apparatus according to claim 14, wherein
the interface is a communication interface that communicates with a server apparatus, and
the processor acquires a count value indicating a usage condition in another image forming apparatus from the server apparatus as information corresponding to the count value.

17. The image forming apparatus according to claim 14, further comprising
a nearly full level sensor that detects that the waste toner stored in the storage unit has reached a predetermined amount corresponding to a nearly full state, wherein
the processor calculates, based on the information acquired from the external apparatus, a correction value for nearly full state display indicating a display timing from when the nearly full level sensor detects that the amount of the waste toner stored in the storage unit reaches the predetermined amount to when the display unit displays the information indicating that the storage unit is nearly full, and causes the display unit to display the information indicating that the storage unit is nearly full at the display timing indicated by the correction value for the nearly full state display.

18. The image forming apparatus according to claim 17, wherein
the processor calculates the correction value for the nearly full state display by adding an adjustment value based on the information acquired from the external apparatus to a correction value for previous nearly full state display.

19. The image forming apparatus according to claim 16, wherein
the processor calculates a nearly full state threshold to be adjusted based on the information acquired from the server apparatus, and causes the display unit to display the information indicating that the storage unit is nearly full when a predicted value of an amount of the waste toner calculated based on a value indicating a usage condition of the image forming apparatus after the storage unit is replaced reaches the nearly full state threshold.

20. The image forming apparatus according to claim 14, wherein
the processor corrects a predicted value of an amount of the waste toner based on the count value stored in the memory, and causes the display unit to display the information indicating that the storage unit is nearly full when the corrected predicted value of the amount of the waste toner reaches the nearly full state threshold.
